(19) United States
(12) Patent Application Publication
(10) Pub. No.: US 2017/0353030 A1
(43) Pub. Date: Dec. 7, 2017

(54) SYSTEM AND METHOD FOR DISTRIBUTING POWER

(71) Applicant: Abdulrahman AL JABRI, Riyadh (SA)

(72) Inventor: Abdulrahman AL JABRI, Riyadh (SA)

(21) Appl. No.: 15/172,874

(22) Filed: Jun. 3, 2016

(51) Int. Cl. H02J 3/00; G06K 19/07; G06Q 30/02; G06Q 50/06

(52) U.S. Cl. CPC H02J 3/005; G06Q 50/06; G06K 19/0715; G06Q 30/0283

(57) ABSTRACT

A system includes a load balancing unit configured to distribute power from a plurality of AC power sources to a plurality of loads. The system further includes a monitoring unit configured to monitor an energy consumption from each AC power source and a power consumption of each load. The system further includes a user interface configured to receive a user preference. The system also includes a controller configured to determine a QoS parameter for each AC power source and regulate, by the load balancing unit, the distribution of power from the plurality of AC power sources to the plurality of loads based on the energy consumption from each AC power source, a power rating of each load, the QoS parameter of each AC power source, a tariff rate of each AC power source and the user preference.

### BACKGROUND

### Field

Embodiments of the present invention generally relate to a system and a method to distribute power from multiple AC power sources to multiple loads, and particularly to a system and a method for switching and balancing power across multiple loads.

### Description of Related Art

AC power supply is required in multiple areas, such as, but not restricted to, residential buildings, industries and other commercial areas, streets, and the like, which have a large number of electrical devices. As the number of electrical appliances increase, the energy consumption becomes high, which further makes it difficult to control the usage of the electrical devices. As a result, monitoring of the usage and performance of the electrical appliances to reduce energy consumption is not feasible.

Multiple sources of power supply from different electricity vendors may be provided to meet the energy requirements of the electrical devices. However, having power supply sources with different Availability of Service (AoS) can lead to improper distribution of power between the multiple loads. Further, increasing demand for power can lead to the electricity vendors imposing slab based tariffs and rolling blackouts. The slab based tariffs results in variable rates of electric power. Specifically, the rates vary based on different periods at which the electricity is consumed, for example, electricity rates are greater at peak hours, i.e., during day time, while the rates are less at night. Alternatively, the electricity rates may vary depending upon factors like, but not restricted to, season, time of the day, month, and the like.

In cases where multiple power sources are used, the users may have to select the electrical devices to connect with a specific power source. Such selections may not be optimum due to the user's limited knowledge. Moreover, such manual selections may not be catering to various dynamic or unforeseen situations, such as overloads, blackouts etc.

Further, availability of continuous power supply and quality of service is vital in some situations, such as, but not restricted to, medical applications, space exploration labs, and so forth. In such cases, inability to meet requirements related to continuous power supply and quality of service may lead to catastrophic situations.

Generally, load balancing units are deployed to provide power supply to the electrical devices in order to minimize human intervention. However, the load balancing units do not provide power supply on the basis of Quality of Service (QoS) and/or Availability of Service (AoS). Further, the conventional load balancing units balance the loads statically, and not dynamically. Also, the load balancing units do not consider factors like, but not restricted to, data security, user preferences, which are important for systematic operation of the load balancing units. Thus, the load balancing units may require human intervention and knowledge for efficient operation, thereby limiting efficiency and performance of the balancing units.

Also, load balancing units do not provide information regarding attributes like, but not limited to, damaged loads, unusual or over usage of a particular load, action against a hacker, an appliance crossing any particular user-defined limit, switching frequency, balancing ratio, and so forth. Related art further does not distinguish between the load with same and/or different ratings. For example, if two fans with same power rating of 10 Watts are connected or different appliances like a fan and an electric bulb with same power rating of 5 Watts are connected then the load balancing unit is unable to differentiate between the loads. Inability to differentiate may lead to improper distribution of power as the load balancing units fail to consider dynamic power requirements of different loads with the same power rating.

Therefore, at least due to the aforementioned reasons, conventional load balancing units may not make optimum switching decisions while providing power to different loads from different power sources.

Conventional load balancing units can also be susceptible to hacking and manipulation by unauthorized users. Unauthorized access may especially be damaging to critical systems, such as defense installations, biohazard facilities etc.

There is thus a need for a system and a method for controlling distribution of power from multiple power sources to different loads in a dynamic manner based on Quality of Service (QoS), user preferences, details of electrical devices, and other parameters, while preventing unauthorized access.

### SUMMARY

Embodiments in accordance with the present invention provide a system for use with a plurality of Alternating Current (AC) power sources and a plurality of loads. The system includes a load balancing unit configured to distribute power from the plurality of AC power sources to the plurality of loads. The system further includes a monitoring unit configured to monitor an energy consumption from each of the plurality of AC power sources and a power consumption of each of the plurality of loads. The system further includes a communication unit configured to receive a load identifier corresponding to each of the plurality of loads, wherein the load identifier is at least indicative of a power rating of the corresponding load. The system further includes a memory unit configured to store historical data corresponding to each of the plurality of AC power sources and a tariff rate of each of the plurality of AC power sources. The system further includes a user interface configured to receive a user preference comprising at least one of a Quality of Service (QoS) from the plurality of AC power sources, a cost associated with the energy consumption from the plurality of AC power sources and a maximum power limit for at least one load of the plurality of loads. The system further includes a controller communicably coupled to the load balancing unit, the monitoring unit, the communication unit, the memory unit and the user interface, the controller configured to determine a QoS parameter for each of the plurality of AC power sources based on the historical data corresponding to each of the plurality of AC power sources; regulate, by the load balancing unit, the distribution of power from the plurality of AC power sources to the plurality of loads based on at least the energy consumption from each of the plurality of AC power sources, the power rating of each of the plurality of loads, the QoS parameter of each of the plurality of AC power sources, the tariff rate of each of the plurality of AC power sources and the user preference; and display, through the user interface, at least one of the energy consumption from each of the plurality of AC power sources, the power consumption of each of the plurality of loads and the distribution of power from the plurality of AC power sources to the plurality of loads.

Embodiments in accordance with the present invention further provide a method of distributing power from a plurality of Alternating Current (AC) power sources to a plurality of loads. The method includes monitoring an energy consumption from each of the plurality of AC power sources and a power consumption of each of the plurality of loads. The method further includes receiving a load identifier corresponding to each of the plurality of loads, wherein the load identifier is at least indicative of a power rating of the corresponding load. The method also includes determining a Quality of Service (QoS) parameter for each of the plurality of AC power sources based on the historical data corresponding to each of the plurality of AC power sources. The method further includes receiving a user preference indicative of at least one of a QoS from the plurality of AC power sources, a cost associated with the energy consumption from the plurality of AC power sources and a maximum power limit for at least one of the plurality of loads. The method further includes regulating the distribution of power from the plurality of AC power sources to the plurality of loads based on at least the energy consumption from each of the plurality of AC power sources, the power rating of each of the plurality of loads, the QoS parameter of each of the plurality of AC power sources, a tariff rate of each of the plurality of power sources and the user preference. The method also includes displaying at least one of an energy consumption from each of the plurality of AC power sources, the power consumption of each of the plurality of loads and the distribution of power from the plurality of AC power sources to the plurality of loads

Embodiments in accordance with the present invention further provide a system for use with a plurality of Alternating Current (AC) power sources and a plurality of loads. The system includes a load balancing unit configured to distribute power from the plurality of AC power sources to the plurality of loads; a monitoring unit configured to monitor an energy consumption from each of the plurality of AC power sources and a power consumption of each of the plurality of loads; a communication unit including a Radio-Frequency Identification (RFID) reader configured to receive a load identifier from a RFID tag associated with a corresponding load of the plurality of loads, wherein the load identifier is at least indicative of a power rating of the corresponding load; a memory unit configured to store historical data corresponding to each of the plurality of AC power sources and a tariff rate of each of the plurality of AC power sources, wherein the historical data corresponding to each of the plurality of AC power sources includes a power fluctuation data and an Availability of Service (AoS) data; a user interface configured to receive a user preference indicative of at least one of a Quality of Service (QoS) from the plurality of AC power sources, a cost associated with the energy consumption from the plurality of AC power sources and a maximum power limit for at least one of the plurality of loads; and a controller communicably coupled to the load balancing unit, the monitoring unit, the communication unit, the memory unit and the user interface. The controller is configured to determine a QoS parameter for each of the plurality of AC power sources based on the historical data corresponding to each of the plurality of AC power sources; regulate, by the load balancing unit, the distribution of power from the plurality of AC power sources to the plurality of loads based on at least the energy consumption from each of the plurality of AC power sources, the power rating of each of the plurality of loads, the QoS parameter of each of the plurality of AC power sources, the tariff rate of each of the plurality of power sources and the user preference; and display, through the user interface, the energy consumption from each of the plurality of AC power sources, the power consumption of each of the plurality of loads and the distribution of power from the plurality of AC power sources to the plurality of loads.

Embodiments in accordance with the present invention further provide a system and a method to dynamically distribute power between multiple loads in order to maintain an optimum balancing ratio and switching count, thereby preventing overload on one or more power sources and increasing life of various components.

Embodiments in accordance with the present invention further provide a system and a method to distribute power based on Quality of Service (QoS) of power sources, thereby providing continuous and uniform power to particular loads selected by the user.

Embodiments in accordance with the present invention further provide a system and a method to display power/energy consumption data and switching data to a user in order to enable the user to make better decisions.

Embodiments in accordance with the present invention further provide a system and a method to monitor load performance and generate alerts indicative of a load malfunction.

Embodiments in accordance with the present invention further provide a system and a method to prevent unauthorized access of a load balancing unit.

These and other advantages will be apparent from the present application of the embodiments described herein.

The preceding is a simplified summary to provide an understanding of some embodiments of the present invention. This summary is neither an extensive nor exhaustive overview of the present invention and its various embodiments. The summary presents selected concepts of the embodiments of the present invention in a simplified form as an introduction to the more detailed description presented below. As will be appreciated, other embodiments of the present invention are possible utilizing, alone or in combination, one or more of the features set forth above or described in detail below.

### BRIEF DESCRIPTION OF THE DRAWINGS

The above and still further features and advantages of embodiments of the present invention will become apparent upon consideration of the following detailed description of embodiments thereof, especially when taken in conjunction with the accompanying drawings, and wherein:

FIG. 1 is an exemplary system for distributing power, according to an embodiment of the present disclosure;

FIG. 2 illustrates a functional block diagram of the system, according to an embodiment of the present disclosure;

FIG. 3 depicts a flowchart of a method for distributing of power among multiple loads, according to an embodiment of the present disclosure;

FIG. 4 depicts a flowchart of a method of distributing power among multiple loads, according to another embodiment of the present disclosure;

FIG. 5 depicts various information displayed on a user interface, according to an embodiment of the present disclosure;

FIG. 6 is a schematic of a system for distributing power, according to another embodiment of the present disclosure; and

FIG. 7 is a schematic of a system for distributing power, according to yet another embodiment of the present disclosure; and

While embodiments of the present invention are described herein by way of example using several illustrative drawings, those skilled in the art will recognize the present invention is not limited to the embodiments or drawings described. It should be understood the drawings and the detailed description thereto are not intended to limit the present invention to the particular form disclosed, but to the contrary, the present invention is to cover all modification, equivalents and alternatives falling within the spirit and scope of embodiments of the present invention as defined by the appended claims.

The headings used herein are for organizational purposes only and are not meant to be used to limit the scope of the description or the claims. As used throughout this application, the word “may” is used in a permissive sense (i.e., meaning having the potential to), rather than the mandatory sense (i.e., meaning must). Similarly, the words “include”, “including”, and “includes” mean including but not limited to. To facilitate understanding, like reference numerals have been used, where possible, to designate like elements common to the figures. Optional portions of the figures may be illustrated using dashed or dotted lines, unless the context of usage indicates otherwise.

### DETAILED DESCRIPTION

The term “a” or “an” entity refers to one or more of that entity. As such, the terms “a” (or “an”), “one or more” and “at least one” can be used interchangeably herein. It is also to be noted that the terms “comprising”, “including”, and “having” can be used interchangeably.

A few inventive aspects of the disclosed embodiments are explained in detail below with reference to the various figures. Exemplary embodiments are described to illustrate the disclosed subject matter, not to limit its scope, which is defined by the claims. Those of ordinary skill in the art will recognize a number of equivalent variations of the various features provided in the description that follows.

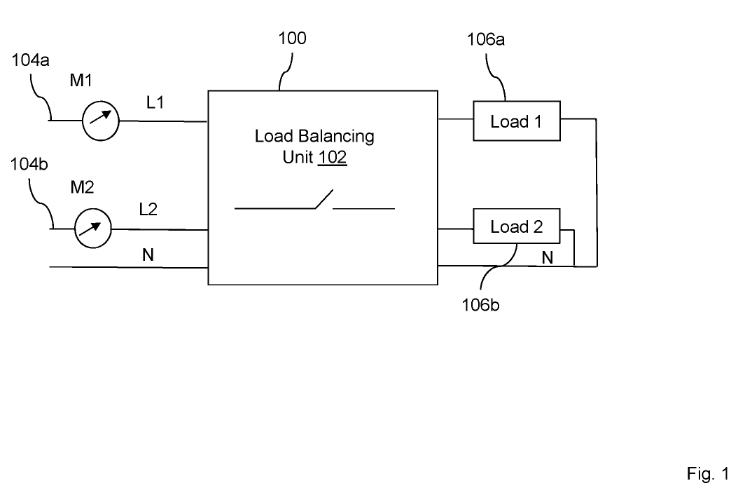

FIG. 1 is an exemplary system 100 for distributing power and balancing load, in accordance with an embodiment of the disclosed subject matter. The system 100 includes a load balancing unit 102 for distributing power obtained from multiple power sources among multiple loads.

Embodiments are intended to include or otherwise cover any type of load balancing unit 102 that can manage power distribution among multiple loads. Load distribution or management can involve balancing between the power supplied by multiple AC sources and the power required by the connected loads.

In the illustrated embodiment, the load balancing unit 102 is connected to two separate Alternating Power (AC) power sources 104a and 104b (hereinafter collectively referred to as “the AC power sources 104”). The AC power sources 104a and 104b may belong to different electricity service providers or vendors. The AC power sources 104a and 104b may be single phase or multi-phase AC power sources. The AC power sources 104a and 104b can be connected by power supply lines or connections ‘L1’ and ‘L2’ to corresponding energy meters ‘M1’ and ‘M2’. The load balancing unit 102 distributes power received from the AC power sources among loads 106a and 106b (hereinafter collectively referred to as “the loads 106”). The power supply lines ‘L1’ and ‘L2’ are connected to the load balancing unit 102 via corresponding electrical connectors (not shown). Similarly, the loads 106a and 106b are connected to the load balancing unit 102 via corresponding electrical connections (not shown). In an example, the loads 106a may be driven by AC power source 104a, while the load 106b may be driven by the AC power source 104b. The load balancing unit 102 can be configured to switch the power supply to the loads 106a and 106b based on various parameters. Further, a neutral line ‘N’ can also pass through the load balancing unit 102.

Though two AC power sources 104a and 104b, and two loads 106a and 106b are illustrated in FIG. 1, the system 100 can distribute power from any number of AC power sources to any number of loads. Further, the loads 106a and 106b may be inductive, resistive, capacitive, or a combination thereof. The loads 106a and 106b can also have different combinations of impedances. Each of the loads 106a and 106b can be an appliance, such as, but not restricted to, a refrigerator, an air-conditioner, a television, a fan, a lighting device, laptops, desktops, kitchen equipment, and the like. The loads 106a and 106b can also be any industrial equipment, such as heavy machinery, machine tools, electric furnaces, cold storages, laboratory equipment, defense installations and so forth.

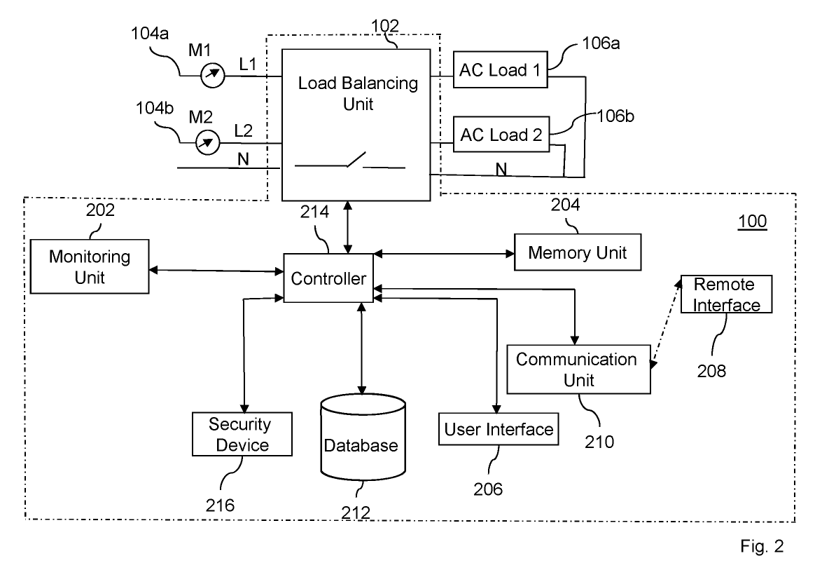

The system 100 can also include additional components for managing or distributing power. The system 100 is described hereinafter in greater detail with reference to FIG. 2.

FIG. 2 illustrates various components of the system 100, in accordance with an embodiment of the disclosed subject matter. In the illustrated embodiment, the system 100 includes a balancing unit 102, a monitoring unit 202, a memory unit 204, a user interface 206, a remote interface 208, a communication unit 210, a database 212, a controller 214, and a security device 216. In fact, embodiments of the disclosed subject matter are intended to include or otherwise cover any number of components in the system 100 to control the power distribution among the loads 106 in a planned manner.

The monitoring unit 202 can be configured to monitor various parameters, for example, but not restricted to, the energy consumption from each of the AC power sources 104, the power consumption of each of the multiple loads 106, a voltage across each of the loads 106, a current flowing through each of the loads 106, and the like. Further, the monitoring unit 202 provides this information to the user via the user interface 206. The monitoring unit 202 can be, but not restricted to an electric meter, energy meter, and the like. In the illustrated embodiment, the monitoring unit 202 may be communicably coupled to the energy meters ‘M1’ and ‘M2’ in order to monitor the energy consumption from each of the AC power sources 104. The monitoring unit 202 may also include one or more voltmeters and ammeters to monitor the voltages across the loads 106 and the currents flowing through the loads 106. In fact, embodiments of the disclosed subject matter are intended to include otherwise cover any type of device that can be used to monitor the aforementioned energy, power, voltage and current parameters.

In some embodiments, the monitoring unit 202 can also provide monitoring of additional parameters such as, but not restricted to, current billing information of all the meters (e.g., ‘M1’ and ‘M2’), previous billing per meter, cost saved per meter and total cost saved, electricity failure per line, and so forth. The monitoring unit 202 may retrieve various data from the database 212 or the memory unit 204 including tariff rates for each of the AC power sources 104, billing history, power outage or failure history, and the like, to determine the additional parameters.

In some embodiments, the monitoring unit 202 can be an on-site monitoring device and can be an integral component of the system 100. In alternative embodiments, the monitoring unit 202 can be an off-site monitoring device and is communicably coupled to the various components of the system 100 via the communication unit 210. Moreover, the monitoring unit 202 can be part of the remote interface 208 and receive all data wirelessly.

In some other embodiments, the monitoring unit 202 can be registered with the system 100 before carrying out the various monitoring activities. Further, the monitoring unit 202 can be configured to inform the controller 214 about one or more events like, but not restricted to, any of the loads 106 exceeding its set limits, any damage to and/or malfunctioning of the loads 106, and so forth.

The memory unit 204 can be configured to store the data monitored by the monitoring unit 202, the historical data corresponding to each of the AC power sources 104 and the tariff rates of each of the AC power sources 104. The historical data corresponding to each of the AC power sources 104 includes, but not restricted to, power fluctuation data, Availability of Service (AoS) data, and the like. The memory unit 204 can include, but not restricted to Random Access Memory (RAM), Read Only Memory (ROM), Programmable Read Only Memory (PROM), Erasable Programmable Read Only Memory (EPROM), Electrically Erasable Programmable Read Only Memory (EEPROM), flash memory, optical memory, magnetic tapes and so forth. In fact, embodiments of the disclosed subject matter are intended to include or otherwise cover any type of, memory unit including known, related art, and/or later developed technologies to store data related to the system 100

In some embodiments, the database 212 can be a relational database, an object-oriented database, and the like. The database 212 may be based on Structured Query Language (SQL). Further, the database 212 may be an onsite database and stored on the memory unit 204. Alternatively, the database 212 may be stored on a central server (not shown). The controller 214 can retrieve data from the memory unit 204 via the communication unit 210.

In some embodiments, the user interface 206 is configured to enable the user to interact with the system 100. The user interface 206 can be an on-site interface and communicably coupled to various components of the system 100. The user may provide data, such as, but not restricted to, name, type, location, and the like, for the connected loads 106. The user interface 206 may include, but not restricted to, a display (not shown) configured to display information related to the system 100. The user interface 206 may also be configured to receive user inputs via a keyboard, a touchpad, a touchscreen, voice recognition etc. In fact, embodiments of the disclosed subject matter are intended to include or otherwise cover any type of user interface, including known, related art and/or later developed technologies to provide an interface to the user to interact with the system 100.

In some other embodiments, the user interface 206 can be configured to enable the user to provide information, such as authentication data, to identify a valid user. The user interface 206 can also generate a registration form with various data fields provided by the manufacturer. The user can register by filling in the different data fields of the registration form. The controller 214 may receive data inputted by the user via the communication unit 210 and may store the data in the memory unit 204 or the database 212. A controller 214 may create a user account with the authentication data. The system 100 is further configured to identify the user and enable the user to login to the user account upon receiving the authentication data, such as, but not restricted to, a pre-set password and a user id, an OTP (One-time Password), and the like. The authentication data can avoid or impede any unauthorized access to the system 100. Further, the user can be provided with administrator privileges upon authentication and can set various user preferences, including, but not restricted to, Quality of Service (QoS) of the AC power sources 104, a cost or billing amount associated with the energy consumption from each of the AC power sources 104, a maximum power limit of each of the loads 106, and so forth, by logging into the system 100 through a password protected panel. In an embodiment, the user preferences include whether QoS should be given higher priority or cost/billing associated with the AC power sources 104 should be given higher priority. In further embodiments, the user preferences may include weights assigned to QoS and cost.

In some embodiments the user can log into the system 100 via the remote interface 208. The remote interface 208 can include, but not restricted to, a laptop, a desktop computer, a mobile phone, a wearable electronic device, a Personal Digital Assistant (PDA), and the like. The remote interface 208 can an off-site device communicably coupled to the system 100 via the communication unit 210. The remote interface 208 can be a web portal or an enterprise portal and is configured to receive data and provide information in a manner similar to the user interface 206. Specifically, the remote interface 208 can allow user registration in addition to user login. The user may have to register the remote interface 208 with system 100 before using the remote interface 208 to login to the system 100, and retrieve or modify information. The registration of the remote interface 208 may be carried out via an OTP (One-time Password) scheme.

Further, in some embodiments, the user interface 206 or the remote interface 208 can receive various input parameters from the user in addition to user information and authentication information. The input parameters may be required by the system 100 for optimum functioning, such as, but not restricted to, meter information, phase configuration of the AC power sources 104, system time configuration, billing dates for each of the AC power sources 104a and 104b, switching configuration and strategy, optimum balancing ratios, a balancing mode, failure alarms, a minimum switching count of the load balancing unit, a maximum switching count of the load balancing unit 102, and so forth. The input parameters may be stored in the memory unit 204.

The meter information may include a meter identifier associating each of the energy meters ‘M1’ and ‘M2’ with the corresponding AC power sources 104a and 104b, and a maximum balancing power of each of the energy meters ‘M1’ and ‘M2’. Thus, the load balancing unit 102 may identify a number and type of the energy meters ‘M1’ and ‘M2’ that need to be balanced in terms of power and energy consumption. The maximum balancing power may include a maximum power that each of the energy meters ‘M1’ and ‘M2’ can handle. In an example, the maximum balancing power can include a maximum current and a maximum voltage. Further, the meter information can include a metering rating of each of the energy meters ‘M1’ and ‘M2’ including a base current and a base voltage.

The phase configurations can include information regarding a phase of each of the AC power sources 104 including whether the AC power sources 104 are single phase, dual phase, and/or three phase. The system time configuration can be system time and system date that may be required to calculate billing information and energy consumption.

The switching configuration and strategy can be one of a minimum switching, a maximum balance and adaptive switching. Minimum switching strategy may include minimizing the switching counts between the AC power sources 104. Maximum balance can include minimizing a difference between the energy consumption from the AC power sources 104. In other words, maximum balance involves a strategy of even distribution of the power requirements among the AC power sources. Further, a balancing ratio may be a difference between the energy consumption from the AC power sources 104. In some embodiments, the user may also input desired or optimum balancing ratios between the AC power sources 104. The balancing ratios may be 2%, 5% and 10%. For example, a balancing ratio of 2% may indicate a division of 52% and 48% of the total power requirement among the AC power sources 104.

Adaptive switching may involve a trade-off between the balancing ratio and the switching count. Adaptive switching may try to keep the switching count between a minimum switching count and a maximum switching count in order to achieve the desired balancing ratios. In order words, adaptive switching strategy involves keeping the switching count within a predetermined switching count range defined by the minimum switching count and the maximum switching count, while trying to achieve the desired balancing ratios. Minimum switching count is the minimum number of switches that the load balancing unit 102 can implement in order to maintain the preset balancing ratio or minimize the current balancing ratio. The maximum switching count is the maximum number of switching that the load balancing unit 102 can implement without reducing a lifetime or causing damage to various components of the load balancing unit 102. Switching count may be measured in terms of number of switches per unit of time (seconds, milliseconds etc.). The switching count information may be provided by the user or may be provided by the manufacturer. Providing these parameters to the system 100 may allow the system 100 to function accordingly.

The user may also be allowed to enable or disable a balancing mode. When the balancing mode is disabled, the system 100 may attempt to minimize the switching count.

Further, the user interface 206 or the remote user interface 208 display options to set maximum allowed energy consumption for each of the loads 106 to avoid or impede the overloading of any of the energy meters ‘M1’ or ‘M2’, minimizing energy costs and detect any malfunctioning of the connected loads 106. The user interface 206 or the remote user interface 208 can notify the user about the energy consumption of each of the connected loads 106 and generate alerts based on overloading or overconsumption of energy.

In some embodiments, the user interface 206 can be configured to provide a measure of health of each of the loads 106 to the user over a time period based on the monitoring of the power consumption and/or detection of any malfunctioning of each of the loads 106 via the monitoring unit 202. Further, historical data of each of the loads 106 can be used to monitor health of each of the loads 106 as well as predict future behavior of the loads 106. Such prediction of future behavior may be required in critical applications, such as medical applications, defense applications, and the like.

The user can also set critical parameters and create a priority list of the critical parameters in the system 100. One of the critical parameters that can be given higher priority can be either cost of electricity (billing) or Quality of Service (hereinafter, referred to as “QoS”). Billing is associated with the cost of consumed electricity, and if given priority, the system 100 may focus on reducing the electricity bill.

Electricity distribution can be billed as per slab of usage, i.e., a higher slab has higher tariff rates. The system 100 switches the power supply connections ‘L1’ and ‘L2’ between the loads 106, so that the overall consumption of the electricity can be equally divided between the AC power sources 104. The power supply connections ‘L1’ and ‘L2’ are connected to the controller 214, which regularly monitors the energy consumption from each of the power sources 104 through the monitoring unit 202. The controller 214 may decide whether to switch one of the loads 106 on either of the AC power sources 104 based on the monitored energy consumption. Therefore, the system 100 manages equal distribution among the AC power sources 104 resulting in low tariff rates for the user.

In an exemplary scenario, if a user has multiple power supply connections, then the user is billed for both the connections as per the usage slab. Further, the energy consumption can be a balance between both the connections. As the energy consumption is variable, it may lead to one of the connections having more load than the other, while the other one is not being fully utilized. For example, if the energy consumption from the AC power source 104a is in the lower end of a first slab and the energy consumption from the AC power source 104b is in a mid or a lower end of a slab 2, the user can be billed in slab 1 for the AC power source 104a and slab 2 for the AC power source 104b. Accordingly, the system 100 switches the connections ‘L1’ and ‘L2’ between the appropriate loads 106 in order to maximize utilization of power provided by the AC power source 104a and make the power consumption for both the AC power sources 104a and 104b fall in the same slab. Therefore, the system 100 can ensure that the user cannot be charged extra for the same power consumption.

Further, QoS can be another parameter, for which the user can set a priority. The user can choose bill, QoS or a combination of QoS, bill and usage slabs used for calculating the bill. For example, the user can set the priority as 70% for reduction of the bill and 30% for QoS on the password protected panel of the user interface 206 or the remote user interface 208. QoS may be determined based on multiple QoS parameters associated with each of the AC power sources 104. In some embodiments, QoS for each of the AC power sources 104 can be calculated based on the historical data corresponding to each of the AC power sources 104. Historical data may include, but not restricted to, a power fluctuation data and an Availability of Service (hereinafter, referred to as AoS) corresponding to each of the AC power sources. In some embodiments, the controller 214 can apply averaging or other statistical analyses, and/or probabilistic models to calculate QoS based on historical data. Furthermore, QoS may also be calculated or refined dynamically based on real time data.

In some embodiments, the user interface 206 may display information about each of the connected loads 106 including, their power limits, power and energy consumption within a period (for example, a billing cycle), distribution of power from all the AC power sources 104 to the loads 106, energy consumption from each of the AC power sources 104, power consumption through each of the energy meters ‘M1’ and ‘M2’, and so forth. Such information can be displayed in one or more graphical formats and can be modified based on user defined display options and filters (for example, time, any specific load 106 or AC power source 104 etc.).

The communication unit 210 can be configured to communicate user preference data from the user interface 206 or the remote user interface 208 to the controller 214. Further, the communication unit 210 can be configured to communicate historical data of AC power sources 104, and current and historical power consumption data of the loads 106 to the memory unit 204. The controller 214 can access such data for the efficient functioning of the system 100. In some embodiments, the communication unit 210 can be configured to receive a load identifier via a communication network corresponding to each of the loads 106, the load identifier being indicative of various parameters of each of the loads 106, such as, but not restricted to power rating of the corresponding loads 106, a voltage rating, a name associated with each of the loads 106, a performance history of each of the load 106, manufacturer information, and the like.

In some embodiments, the communication network may include a data network such as, but not restricted to, the Internet, local area network (LAN), wide area network (WAN), metropolitan area network (MAN), etc. In certain embodiments, the communication network can include a wireless network, such as, but not restricted to, a cellular network and may employ various technologies including enhanced data rates for global evolution (EDGE), general packet radio service (GPRS), global system for mobile communications (GSM), Internet protocol multimedia subsystem (IMS), universal mobile telecommunications system (UMTS) etc. In some embodiments, the communication network may include or otherwise cover networks or subnetworks, each of which may include, for example, a wired or wireless data pathway. The communication network may include a circuit-switched voice network, a packet-switched data network, or any other network capable for carrying electronic communications. For example, the network may include networks based on the Internet protocol (IP) or asynchronous transfer mode (ATM), and may support voice usage, for example, VoIP, Voice-over-ATM, or other comparable protocols used for voice data communications. In one implementation, the network includes a cellular telephone network configured to enable exchange of text or SMS messages.

Examples of the communication network may also include, but not limited to, a personal area network (PAN), a storage area network (SAN), a home area network (HAN), a campus area network (CAN), a local area network (LAN), a wide area network (WAN), a metropolitan area network (MAN), a virtual private network (VPN), an enterprise private network (EPN), Internet, a global area network (GAN), and so forth. Embodiments are intended to include or otherwise cover any type of communication network, including known, related art, and/or later developed technologies to communicate between the controller 214 and the other units of the system 100.

In some other embodiments the communication unit 210 can include, but not restricted to, a Radio Frequency Identification (RFID) reader (not shown), which can be configured to receive the load identifier from an RFID tag associated with each of the corresponding loads 106. I

In yet some other embodiments, the communication unit 210 can be configured to communicate information set by the user about the loads 106 to the database 212. Further, the user can also communicate with each of the units of the system 100 via the communication unit 210. The user can also be informed of every switching event between the loads 106 via different communication means, such as, but not restricted to, RFID (Radio Frequency Identification), Bluetooth, GSM (Global System for Mobiles), Wi-Fi (Wireless-Fidelity), and so forth. Further, the user can also be informed of the slab rates, peak hour timings, etc. The communication unit 210 can be configured to provide audio, visual and/or tactile alarms to inform the user in case of, but not restricted to, damaged appliances, overloading, overconsumption of electrical energy by one or more loads 106, and so forth.

The controller 214 is communicably coupled to the load balancing unit 102, the user interface 206, the monitoring unit 202, the communication unit 210, the memory unit 204, the database 212, and the security device 216. The controller 214 can be configured to determine the QoS parameter for each of the AC power sources 104 based on the historical data received from the memory unit 204 corresponding to each of the AC power sources 104. Further, the controller 214 regulates, by the load balancing unit 102, the distribution of power from the AC power sources 104 to the loads 106 based on, but not restricted to, the QoS parameter, energy consumption from the AC power sources 104, the tariff rate of each of the AC power sources 104, and the user preferences. The controller 214 can be programmed (e.g., via computer program code or instructions) to control the system 100 and includes a communication mechanism such as a bus (not shown) for exchanging information (also data) between other internal and external components of the system 100. The bus includes one or more parallel conductors of information so that information is transferred quickly among devices coupled to the bus. One or more processors for processing information are coupled with the bus. The controller 214 may also be coupled wireless with one or more components of the system 100.

In some embodiments, the controller 214 can be configured to determine a current switching count and a current balancing ratio associated with the load balancing unit 102. The current switching count is indicative of a number of switches between the AC power sources 104 in a given time period, and the current balancing ratio is indicative of a difference in energy consumption from the AC power sources 104. Further, the controller 214 can be configured to modify the balancing ratio of the load balancing unit 102 if the current switching count is lesser than the minimum switching count or the current switching count is greater than the maximum switching count. Also, the controller 214 can be configured to display, through the user interface 206 or the remote user interface 208, the current switching count and the current balancing ratio.

In some other embodiments, the controller 214 can be configured to determine, by the monitoring unit 202, that power consumption of one or more of the loads 106 is greater than the maximum power limit or the corresponding power rating of the respective loads 106, and disconnect, by the load balancing unit 102, the one or more loads 106 from the AC power sources 104. The controller 214 can switch the power supply connections ‘L1’ and ‘L2’ between the multiple AC power sources 104 at any point of time during the operation, such that the one or more of the loads 106 can be supplied with power from only one of the AC power sources 104, or from multiple AC power sources 104. The controller 214 may select which of the AC power sources 104 should supply which of the loads 106 based on the power/energy consumption of the individual loads 106, energy consumption from the AC power sources 104, user preferences, power ratings or user defined power limits for the loads 106, QoS of each of the AC power sources 104, tariff rate of each of the AC power sources 104, switching algorithm or strategy (minimum switching count, maximum balancing ratio or adaptive switching), and so forth.

Further, in an example, the tariff rate can also depend upon at what time the electricity is consumed. In case, multiple electricity connections are from different suppliers or vendors, the tariff rates can also be different. In such cases, the controller 214 in conjunction with the load balancing unit 102 and other units of the system 100 may work to provide reduced electricity bill if the user has opted for low billing while filling preferences. For example, if one slab has low tariff rates and the second one has comparatively higher tariff rates, then controller 214 may instruct the load balancing unit 102 to switch the loads 106 accordingly to reduce the electricity bill. The load balancing unit 102 may allow the cheaper power supply connection to run for a longer time and let the appliances consume maximum energy from the cheaper power supply and then switch to the costlier one. The load balancing unit 102 distributes power in accordance with reducing the electricity bill and maintaining QoS including AoS.

Further, the load balancing unit 102 can be configured to distribute power from the AC power sources 104 to the multiple loads 106 based control signals received from the controller 214. In some embodiments, the load balancing unit 102 includes, but not restricted to, multiple Metal Oxide Semiconductor Field Effect Transistors (MOSFETs) configured to switch the loads 106 from between the AC power source 104a and the AC power source 104b. MOSFETs are used for providing fast switching in the balancing unit 102. In fact, embodiments of the disclosed subject matter are intended to include or otherwise cover any type of MOSFET including known, related art, and/or later developed technologies for switching load between multiple power supplies.

In some embodiments, a pair of MOSFETs (N-MOS and P-MOS) can be used to switch between the loads 106 at a zero voltage crossing moment which provides various advantageous features to the balancing unit 102 including, but not restricted to, higher reliability, smaller size, faster switching times, eliminating switch bounce, eliminating High Voltage (HV) arcing, snubber circuit to minimize voltage spikes, and lower triggering currents.

The security device 216 can be configured to impede or prevent unauthorized access of the system 100. For example, a hacker or an unauthorized user can attack the system 100 and operate it, which may lead to, but not restricted to, damage of the system 100, appliance malfunction and/or damage, increase in bill, and so forth. In fact, embodiments of the disclosed subject matter are intended to include or otherwise cover any type of security device to be used to impede attacks on the system 100. The security device 216 may implement various firewalls and data encryption algorithms stored in the memory unit 204 in order to impede or prevent unauthorized access. The security device 216 may also communicate any instance of unauthorized access to the controller 214. The controller 214 may implement preventive measures, such as shutting down one or more communication channels of the communication unit 210, alert the user through the remote user interface 206, prevent any modifications of existing settings, and so forth.

The controller 214 may include a processor, a microcontroller, and the like. In some embodiments, the processor of the controller 214 can be a single core processor. In some other embodiments, the processor can be a multi-core processor that can be configured to run and/or execute software that is stored in the database 212 and/or the memory unit 204. In alternative embodiments, the processor can be, but not restricted to, a general purpose processor, a Field Programmable Gate Array (FPGA), an Application Specific Integrated Circuit (ASIC), and the like. Embodiments are intended to include or otherwise cover any type of processor, including known, related art, and/or later developed technologies to enhance capabilities of processing data and/or instructions.

The system 100 further implements dynamic and/or adaptive management of load and/or power supply to provide various benefits to the user, such as, but not restricted to, reducing electricity bill, avoiding over or under usage of appliances, and so forth. Load switches can be configured to switch between multiple power supplies on an adaptive basis. Adaptive switching can include managing trade-off between the balancing ratio and the switching count (number of times a switch changes power supply connections). A greater number of switching in a given time period may be required to obtain a good balancing ratio, which in turn may affect the lifetime of the switching device. Therefore, adaptive switching can be used to optimize the switching rate and the balancing ratio. For example, if the switching is very frequent, the adaptive algorithm of the switch can increase the desired or optimum balancing ratio, like from 2% to 10%, which provides more time between two successive switching operations and thus, increases the lifetime of the switching device. On the other hand, if the switching count is less, then the switching frequency can be increased to obtain better balancing of the loads 106 by decreasing the balancing ratio, like from 5% to 2%.

The power supply connections ‘L1’ and ‘L2’ include energy meters ‘M1’ and ‘M2’, respectively, to measure the electric energy consumed used by the connected loads 106. The energy or utility meters ‘M1’ and ‘M2’ have their own voltage rating, current rating and power rating. If these limits are exceeded, the energy meters ‘M1’ and ‘M2’ can malfunction, and provide inaccurate measurements or may suffer from permanent damage. To avoid or impede this situation, the maximum balancing power, which is a configurable parameter based on the ratings of the energy meters ‘M1’ and ‘M2’, is provided to the system 100 to avoid sabotaging the system 100 while balancing. For example, each of the energy meters ‘M1’ and ‘M2’ has a maximum current rating of 100 A, and the loads 106a and 106b has individual current ratings such that the sum of the individual current ratings of the loads 106a and 106b exceed the maximum power rating any of the energy meters ‘M1’ and ‘M2’. The maximum balancing ratio may be chosen as 100 A based on the maximum current rating of each of the energy meters ‘M1’ and ‘m2’. Therefore, if both the loads 106a and 106b are connected to one of the energy meters ‘M1’ or ‘M2’, then overall current may pass through that particular energy meter, which exceeds its rating. Therefore, in such a case, the system 100 may postpone the switching operation until the sum of the loads 106a and 106b falls below or equal to the individual meter ratings, i.e., the maximum balancing power.

In another exemplary scenario, the user may select uninterrupted power supply of high QoS to a specific load, for example, the load 106a. The load 106a may be a critical device, such as a medical ventilator. In such a case, the controller 214 may switch power supply connections ‘L1’ and ‘L2’ to ensure continuous power supply with high QoS to the load 106a irrespective of costs associated with energy consumption.

In yet another exemplary scenario, the controller 214 may switch between the AC power sources 104a and 104b based on peak hour tariff rates. For example, the AC power source 104a may have higher tariff rates during daytime. Therefore, the controller 214 may ensure maximum utilization of the AC power source 104b during daytime.

The system 100 can also include a central server that coordinates functioning of the units of the system 100, while also providing and updating various data and instructions utilized by the controller 214. For example, the central server may update the tariff rates periodically or modify switching strategies or algorithms based on historical data.

In fact, embodiments of the disclosed subject matter are intended to include or otherwise cover any type of techniques and/or systems of managing the distribution of AC power among multiple loads, taking into consideration the user preference of reduction of bill and Quality of Service (QoS) including Availability of Service (AoS) of the AC power supply, or a combination thereof.

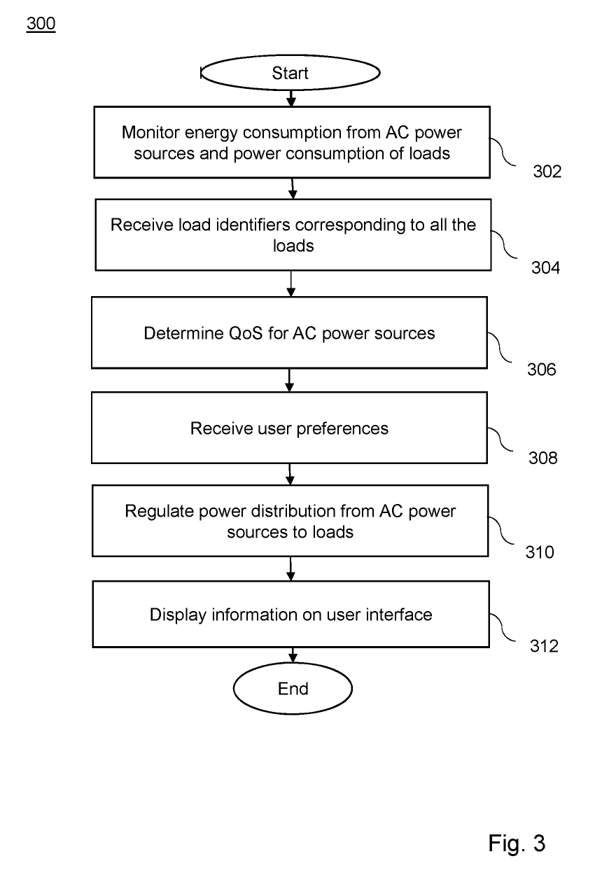

FIG. 3 is a flowchart of a method or a procedure 300 for distributing AC power from AC power sources to loads in accordance with the disclosed subject matter. In some embodiments, the procedure 300 can use the system 100 including the load balancing unit 102 to implement the various steps. The load balancing unit 102 can have multiple power supply lines and multiple loads connected thereto.

In some embodiments, the load balancing unit 102 of the system 100 distributes power from the multiple AC power sources 104 to multiple loads 106 based on control signals from the controller 214. In other embodiments, the load balancing unit 102 distributes power among different and/or different types of loads based on, but not restricted to, user preferences, power ratings of the loads, current ratings of the loads, and so forth. In fact, embodiments of the disclosed subject matter are intended to include or otherwise cover any parameter required to efficiently distribute power from the AC power sources to the loads.

At step 302, the system 100 monitors the amount of energy consumed from the AC power sources 104 and power consumption by the loads 106. In some embodiments, the system 100 includes the monitoring unit 202 that monitors, but not restricted to, which AC power source supplies power to which load, an amount of energy consumed from each of the power sources 104, the power consumed by each load 106, any damage or malfunction of the loads 106, and so forth. In some embodiments, the monitoring unit 202 can communicate such information to the controller 214, the user interface 206 and/or the remote user interface 208. Further, the monitoring unit 202 keeps a track of all the information and stores it in the memory 204.

At step 304, the system 100 receives identifiers of each of the loads 106 connected to the load balancing unit 102, the identifier corresponding to each of the multiple loads 106. In some embodiments, the identifier helps in distinguishing different loads having same power ratings. Therefore, the system 100 has knowledge of individual loads 106, their ratings, their names, their performance history (via the monitoring unit 202) etc.

Further, at step 306, the system 100 determines one or more Quality of service (QoS) parameters for each of the AC power sources 104. QoS also includes Availability of Service (AoS) that is indicative of frequency of blackouts. Further, QoS is further based on, but not restricted to, power fluctuation data. QoS data may help in optimum distribution of power from the AC power sources 104 among the loads 106.

Next, at step 308, the system 100 receives user's preferences via the user interface 206 or the remote user interface 208. The user may indicate a priority of QoS over a cost associated with the energy consumption from the AC power sources 104. For example, if the energy consumption of one of the connections ‘L1’ and ‘L2’ is reaching its slab limit, the user may want to continue with the connection as it may be more reliable and has maintained the QoS guarantee in the past few hours. Further, in some embodiments, the user may indicate a priority of cost associated with the energy consumption from the AC power sources 104 over QoS guarantee. For example, if the user is not doing any critical work and does not need a high QoS, then the user may choose to pay less by not switching to another line with higher QoS.

In some embodiments, the user's preferences may indicate, but not restricted to, QoS from the multiple AC power sources 104, the cost associated with the energy consumption from the multiple AC power sources 104, maximum power limits of the loads 106, and so forth.

At step 310, the system 100 regulates the distribution of power from the AC power sources 104 to the loads 106 based on, but not restricted to, user preferences, the power ratings of each of the connected loads 106, the determined QoS parameters of the AC power sources 104, tariff rates of each of the AC power sources 104, and so forth.

Next, at step 312, the system 100 displays information on the user interface. In some embodiments, the information includes, but not restricted to, power consumptions of each of the loads 106 and/or combined power consumption of all the loads 106, energy consumption from the AC power sources 104, distribution of power from the AC power sources 104 to the loads 106 including switching trends, over and/or under usage of any appliance, damaged or malfunctioned appliance, slab usage, and so forth.

The procedure 300 may further include receiving, through the user interface 206 or the remote user interface 208, user information including authentication data and creating, via the controller 214, a user account in the database 212 based on the user information. The procedure 300 may also include allowing, via the controller 214, the user to login to the user account. The procedure 300 can include receiving, through the user interface 206 or the remote user interface 208, an input parameter indicative of at least one of the meter ratings of the energy meters ‘M1’ and ‘M2” associated with the Ac power sources 104a and 104b, respectively. The input parameter can also include the system time configuration, the billing data of each of the AC power sources 104, the minimum switching count of the load balancing unit 102, and the maximum switching count of the load balancing unit 102. In some embodiments, the controller 214 may regulate the distribution of power from the AC power sources 104 to the load 106 based further on the input parameter.

The procedure 300 can also include determining, via the controller 214, the current switching count and the current balancing ration associated with the load balancing unit 102, and modifying the balancing ration of the load balancing unit 102 if the current switching count is lesser than the minimum switching count or the current switching count is greater than the maximum switching count. The procedure 300 can further include displaying, via the user interface 206 or the remote user interface 208, the current switching count and the current balancing ratio.

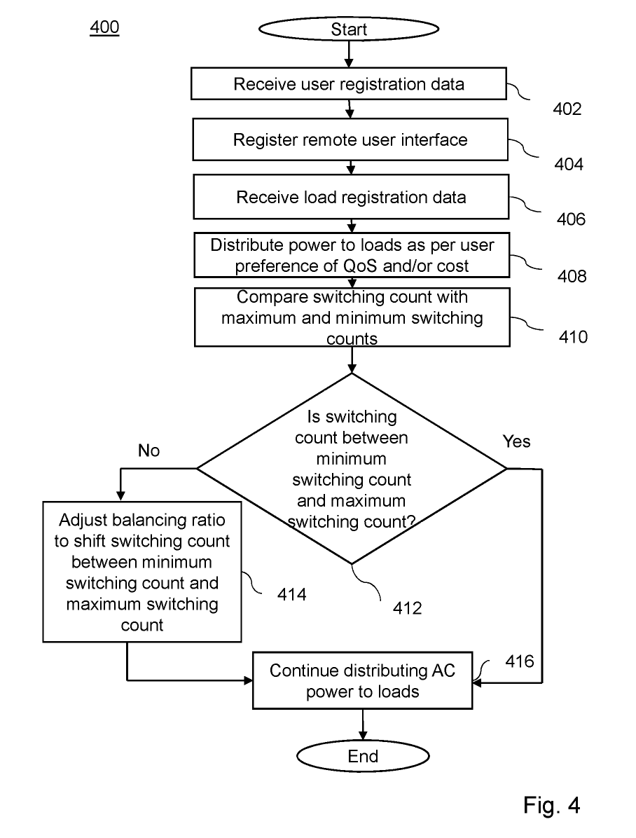

FIG. 4 is a flowchart of a procedure 400 for load management by using the system 100, in accordance with the disclosed subject matter. This flowchart is merely provided for exemplary purposes, and embodiments are intended to include or otherwise cover any methods or procedures for managing load in a system and regulating distribution of AC power supply to the loads.

In accordance with the flowchart of FIG. 4, at step 402, the system 100, through the user interface 206, receives user registration data. The user may have to register by filling in the registration form with registration data that can include unique particulars provided by the manufacturer. The unique particulars can be, but not restricted to, user name, email address, and the like. In some embodiments, the system 100 can be configured to generate a password for the registered user. Further, the user becomes the administrator of the system 100 and can create more users or guests of the system 100.

Next, at step 404, the user registers the remote user interface 208. The user logs into the system 100 through a password protected administrator panel on the user interface 206 or the user can log into the system 100 through a web portal or Application Programming Interface (API). The remote user interface 208 can be, but not restricted to, a phone, a desktop, a laptop, and the like. Further, the user registers the phone number of the device on which various activities can be monitored, such as, but not restricted to, power consumption by the loads 106, information about any damaged or malfunctioning load, energy consumption from the AC power sources 104, and so forth. In case, the remote user interface 208 is not a phone, but another device, such as, but not restricted to, a SIM less tab, a PC in Wi-Fi or Bluetooth, Mac ID, and so forth, the remote user interface 208 can be registered by pairing. In some embodiments, the user can connect a communication device (preloaded with a special application) with the system 100 and fills the parameters, such as, but not restricted to, device name with Mac ID or phone number, etc. In some other embodiments, the system 100 can query the aforementioned parameters related to pairing and registration. In yet some other embodiments, an OTP (One-time password) can be sent to the remote user interface 208 owner by the user to check if the user wants to register the respective device. Further, the system 100 confirms the device registration. In fact, embodiments of the disclosed subject matter are intended to include or otherwise cover any type and number of remote user interfaces that can be configured to monitor the system 100.

Next, at step 406, the user registers all the loads 106 that are to be connected to the system 100. The user connects the load to the system 100 via a wired connection. Alternatively, the load and the system 100 communicates with each other via RFID or other communication methods, such as, but not restricted to, GSM, WIMA, Bluetooth, Wi-Fi, and so forth. The system 100 can be configured to have a RFID reader capable of reading an RFID tag associated with every load. Further, every load has a different RFID tag associated with itself. Therefore, the system 100 can acknowledge parameters like, but not restricted to, the type of load, load ratings, name (fan or bulb), any performance history, and any unusual behavior that can occur in future of the respective load. In some embodiments, the RFID tag can have manufacturer details, such as, but not restricted to, manufacturer type, name, serial number, and so forth.

In some embodiments, the user can set limits on each of the parameters or can leave the parameters in default or ‘Don't Care’ mode. The user can set limits on the loads 106, such as, but not restricted to, limiting the power consumption, disconnecting loads 106 if a certain amount of energy is consumed, limits on the load current, and so forth. The user can also get the aforementioned values into the system 100 through a file created off-line on a device, such as, but not restricted to, a Personal Computer (PC), laptop, and the like. Further, the user can set different parameters for overall functioning of the system 100, like, but not restricted to, options regarding a voice alarm, a siren or information on the phone of the user, preferences related to QoS or cost of electricity or a combination of both for power regulation, and the like. The aforementioned features are programmable and can be programmed remotely via the remote user interface 208.

At step 408, the system 100 regulates distribution of the power in accordance with the user's preferences of QoS and/or cost of the electricity. The load manager takes into consideration parameters mentioned by the user while registering the loads 106, such as, but not restricted to, power ratings of the loads 106, voltage ratings, current ratings, and so forth, while distributing power from AC power sources 104 to the connected loads 106. In fact, embodiments of the disclosed subject matter are intended to include or otherwise cover any type of parameter that a user can set for optimum functioning of the respective loads 106. Further, the system 100 switches the loads 106 to the required AC power source 104 based on the power consumption by the loads 106, voltage ratings, QoS values, cost of electricity, and so forth.

Next, at step 410, the system 100 compares the current switching count with the minimum switching count and the maximum switching count. Current switching count is the number of switches between the multiple AC power sources 104 in a given time period.

Further, at step 412, the load manager determines if the current switching count lies between the minimum switching count and the maximum switching count. In case the current switching count does not lie within the predetermined switching count range defined by the minimum and maximum switching counts, then the procedure 400 proceeds to step 414. At step 414, if the current switching count is more than the maximum switching count, then the system 100 adjusts the balancing ratio, which is a difference in energy consumption from the AC power sources 104. Specifically, the system 100 can increase the balancing ratio (for example, from 2% to 10%) to provide greater time between two successive switching operations. If the current switching count is less than the minimum switching counts then, the system 100 can be configured to achieve better balancing between loads (for example, increasing balancing from 2% to 10%, or from 5% or 2%).

In case, the current switching count lies between the minimum switching count and the maximum switching count, then the procedure 400 proceeds to step 416. At step 416, the system 100 can continue distributing AC power supply to the connected loads as per user preferences to meet the required QoS and cost of the electricity bill.

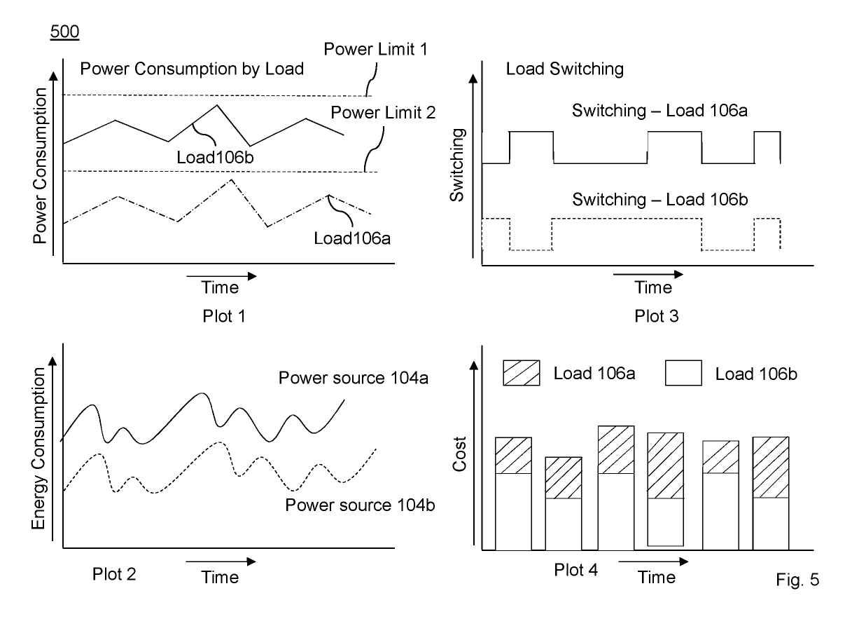

FIG. 5 illustrates various plots that can be displayed by the controller 214 on the user interface 206 or the graphical user interface 208. Plot 1 represents power consumption by each of the loads 106a and 106b over a period of time. The period of time may be a billing cycle, a day, or any other unit of time. The time period may also be chosen by the user. Plot 1 also displays the power limits for each of the loads 106a and 106b. In case, the power consumption of any of the loads 106a and 106b exceeds the corresponding power limits, the controller 214 may generate an alert on the user interface 206 and/or the graphical user interface 208.

Plot 2 depicts energy consumption from each of the AC power sources 104a and 104b over a period of time. The time period may be chosen by the user. Further, in case, the energy consumption by any of the AC power sources 104a and 104b exceeds a predetermined threshold, the controller 214 may generate an alert on the user interface 206 and/or the graphical user interface 208.

Plot 3 represents power consumption by switching of the loads 106a and 106b between the AC power sources 104a and 104b over a time period. Plot 3 can additionally provide switching count data to the user.

Plot 4 shows cost or billing information for both the AC power sources 104a and 104b over a time period. The user can monitor the variations in billing pattern among the AC power sources 104a and 104b, and can modify various user preferences to minimize costs.

The system 100, and the procedures 300 and 400 may therefore enable the user to control and monitor power distribution from multiple AC power sources to multiple loads.

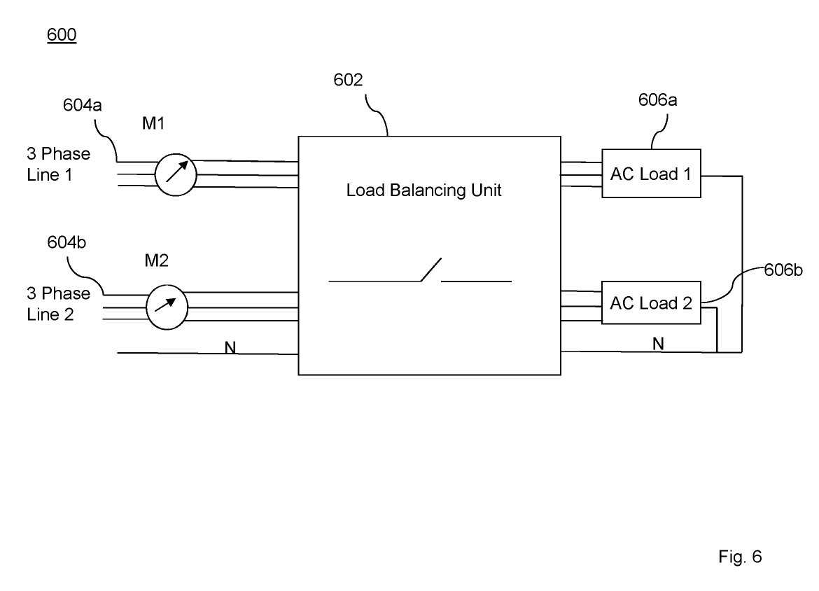

FIG. 6 illustrates a system 600 for distributing power from multiple AC three-phase power sources 604a to multiple AC three-phase loads 606b via a load distributing unit 602. The three-phase power sources 604a and the AC three-phase loads 606b may be connected in various configurations, such as Star configuration, Delta configuration, and the like. The energy meters ‘M1’ and ‘M2’ can be three phase energy meters. Further, the monitoring unit 202 may monitor energy consumption from each of the three phases of the loads 606b. The controller 214 may also switch the loads 606b between phases of a single AC power source 604a based on various parameters, such as QoS of each phase, energy consumption from each phase, overloading of each phase, and the like.

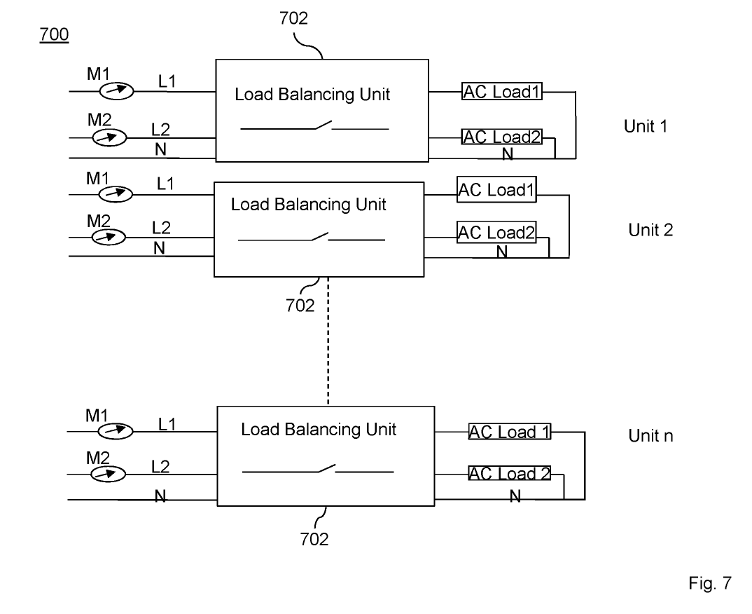

FIG. 7 illustrates a system 700 containing multiple load balancing units 702 installed at multiple power supply connections. For example, if the user has multiple power connections at a location, such as, but not restricted to, a hotel, lodges, hostels, commercial buildings, and the like, the load balancing unit 702 may be provided at each power connection. In fact, embodiments of the disclosed subject matter are intended to include or otherwise cover any type of building or area having multiple power supply connections.

In some embodiments, the system 700 of multiple load balancing units 702 can be configured to have a central device (not shown) for managing and coordinating operations of the load balancing units 702. The central device can be, but not restricted to a desktop, a laptop, a microcontroller, and the like. In fact, embodiments of the disclosed subject matter are intended to include or otherwise cover any type of device that can serve as a central device for coordination between the multiple load balancing units 702 of the system 700. Further, the central device can be configured to manage data, such as, but not restricted to, user inputs, user preferences, historical data of connected and/or coupled appliances, power ratings, energy consumption from the AC power supply sources, power consumption by the loads, and so forth. Further, each of the load balancing units 702 may be controlled separately and can have individual user preferences, balancing rations, switching count ranges, QoS parameters, billing parameters, and so forth.

Although the invention has been described with reference to exemplary embodiments, it is not limited thereto. Those skilled in the art will appreciate that numerous changes and modifications may be made to the preferred embodiments of the invention and that such changes and modifications may be made without departing from the true spirit of the invention. It is therefore intended that the appended claims be construed to cover all such equivalent variations as fall within the true spirit and scope of the invention.

The exemplary embodiments of this present invention have been described in relation to laboratory equipment. However, to avoid unnecessarily obscuring the present invention, the preceding description omits a number of known structures and devices. This omission is not to be construed as a limitation of the scope of the present invention. Specific details are set forth by use of the embodiments to provide an understanding of the present invention. It should however be appreciated that the present invention may be practiced in a variety of ways beyond the specific embodiments set forth herein.

A number of variations and modifications of the present invention can be used. It would be possible to provide for some features of the present invention without providing others.

The present invention, in various embodiments, configurations, and aspects, includes components, methods, processes, systems and/or apparatus substantially as depicted and described herein, including various embodiments, sub-combinations, and subsets thereof. Those of skill in the art will understand how to make and use the present invention after understanding the present disclosure. The present invention, in various embodiments, configurations, and aspects, includes providing devices and processes in the absence of items not depicted and/or described herein or in various embodiments, configurations, or aspects hereof, including in the absence of such items as may have been used in previous devices or processes, e.g., for improving performance, achieving ease and/or reducing cost of implementation.

The foregoing discussion of the present invention has been presented for purposes of illustration and description. It is not intended to limit the present invention to the form or forms disclosed herein. In the foregoing Detailed Description, for example, various features of the present invention are grouped together in one or more embodiments, configurations, or aspects for the purpose of streamlining the disclosure. The features of the embodiments, configurations, or aspects may be combined in alternate embodiments, configurations, or aspects other than those discussed above. This method of disclosure is not to be interpreted as reflecting an intention the present invention requires more features than are expressly recited in each claim. Rather, as the following claims reflect, inventive aspects lie in less than all features of a single foregoing disclosed embodiment, configuration, or aspect. Thus, the following claims are hereby incorporated into this Detailed Description, with each claim standing on its own as a separate embodiment of the present invention.

Moreover, though the description of the present invention has included description of one or more embodiments, configurations, or aspects and certain variations and modifications, other variations, combinations, and modifications are within the scope of the present invention, e.g., as may be within the skill and knowledge of those in the art, after understanding the present disclosure. It is intended to obtain rights which include alternative embodiments, configurations, or aspects to the extent permitted, including alternate, interchangeable and/or equivalent structures, functions, ranges or steps to those claimed, whether or not such alternate, interchangeable and/or equivalent structures, functions, ranges or steps are disclosed herein, and without intending to publicly dedicate any patentable subject matter.

What is claimed is:

1. A system for use with a plurality of Alternating Current (AC) power sources and a plurality of loads, the system comprising:
a load balancing unit configured to distribute power from the plurality of AC power sources to the plurality of loads;
a monitoring unit configured to monitor an energy consumption from each of the plurality of AC power sources and a power consumption of each of the plurality of loads;
a communication unit configured to receive a load identifier corresponding to each of the plurality of loads, wherein the load identifier is at least indicative of a power rating of the corresponding load;
a memory unit configured to store historical data corresponding to each of the plurality of AC power sources and a tariff rate of each of the plurality of AC power sources;
a user interface configured to receive a user preference comprising at least one of a Quality of Service (QoS) from the plurality of AC power sources, a cost associated with the energy consumption from the plurality of AC power sources and a maximum power limit for at least one load of the plurality of loads; and
a controller communicably coupled to the load balancing unit, the monitoring unit, the communication unit, the memory unit and the user interface, the controller configured to:
determine a QoS parameter for each of the plurality of AC power sources based on the historical data corresponding to each of the plurality of AC power sources;
regulate, by the load balancing unit, the distribution of power from the plurality of AC power sources to the plurality of loads based on at least the energy consumption from each of the plurality of AC power sources, the power rating of each of the plurality of loads, the QoS parameter of each of the plurality of AC power sources, the tariff rate of each of the plurality of AC power sources and the user preference; and
display, through the user interface, at least one of the energy consumption from each of the plurality of AC power sources, the power consumption of each of the plurality of loads and the distribution of power from the plurality of AC power sources to the plurality of loads.

2. The system of claim 1, wherein the communication unit comprises a Radio-Frequency Identification (RFID) reader configured to receive the load identifier from a RFID tag associated with the corresponding load.

3. The system of claim 1, wherein the communication unit further comprises a wireless receiver configured to receive, via a wireless network, the load identifier of each of the plurality of loads.

4. The system of claim 1, wherein the load identifier further comprises at least one of a type of load, a name associated with the load, a performance history of the load and manufacturer information.

5. The system of claim 1, wherein the load balancing unit further comprises a plurality of Metal Oxide Semiconductor Field Effect Transistors (MOSFETs) configured to switch at least one of the plurality of loads from one of the plurality of AC power sources to another of the plurality of AC power sources.

6. The system of claim 1, wherein the user interface is further configured to:
receive user information comprising at least authentication data; and
create a user account in a database based on the user information.

7. The system of claim 6, wherein the user interface is further configured to:
enable a user to login to the user account upon receiving the authentication data; and
receive an input parameter indicative of at least one of a meter rating of an energy meter associated with each of the plurality of AC power sources, a phase configuration of each of the plurality of AC power sources, a system time configuration, a billing date of each of the plurality of AC power sources, a minimum switching count of the load balancing unit and a maximum switching count of the load balancing unit;
wherein the controller is further configured to regulate the distribution of power from the plurality of AC power sources to the plurality of loads based on the input parameter.

8. The system of claim 7, wherein the controller is further configured to:
determine a current switching count and a current balancing ratio associated with the load balancing unit, wherein the current switching count is indicative of a number of switches between the plurality of AC power sources in a given time period, and wherein the current balancing ratio is indicative of a difference in energy consumption from the AC power sources; and
modify the balancing ratio of the load balancing unit if the current switching count is lesser than the minimum switching count or the current switching count is greater than the maximum switching count.

9. The system of claim 8, wherein the controller is further configured to display, through the user interface, the current switching count and the current balancing ratio.

10. The system of claim 1, wherein the historical data corresponding to each of the plurality of AC power sources comprises a power fluctuation data and an Availability of Service (AoS) data.

11. The system of claim 1, further comprising a security device configured to prevent unauthorized access to the system.

12. The system of claim 1, wherein the controller is further configured to:
determine, by the monitoring unit, that a power consumption of at least one load is greater than the maximum power limit or the corresponding power rating; and
disconnect, by the load balancing unit, the at least one load from the plurality of AC power sources.

13. A method of distributing power from a plurality of Alternating Current (AC) power sources to a plurality of loads, the method comprising:
monitoring energy consumption from each of the plurality of AC power sources and a power consumption of each of the plurality of loads;
receiving a load identifier corresponding to each of the plurality of loads, wherein the load identifier is at least indicative of a power rating of the corresponding load;
determining a Quality of Service (QoS) parameter for each of the plurality of AC power sources based on the historical data corresponding to each of the plurality of AC power sources;
receiving a user preference indicative of at least one of a QoS from the plurality of AC power sources, a cost associated with the energy consumption from the plurality of AC power sources and a maximum power limit for at least one of the plurality of loads;
regulating the distribution of power from the plurality of AC power sources to the plurality of loads based on at least the energy consumption from each of the plurality of AC power sources, the power rating of each of the plurality of loads, the QoS parameter of each of the plurality of AC power sources, a tariff rate of each of the plurality of AC power sources and the user preference; and
displaying at least one of an energy consumption from each of the plurality of AC power sources, the power consumption of each of the plurality of loads and the distribution of power from the plurality of AC power sources to the plurality of loads.

14. The method of claim 13, wherein the load identifier further comprises at least one of a type of load, a name associated with the load, a performance history of the load and manufacturer information.

15. The method of claim 13, further comprising:
receiving user information comprising at least authentication data; and
creating a user account in a database based on the user information.

16. The method of claim 15, further comprising:
allowing a user to login to the user account upon receiving the authentication data; and
receiving an input parameter indicative of at least one of a meter rating of an energy meter associated with each of the plurality of AC power sources, a phase configuration of each of the plurality of AC power sources, a system time configuration, a billing date of each of the plurality of AC power sources, a minimum switching count of the load balancing unit and a maximum switching count of the load balancing unit; and
regulating the distribution of power from the plurality of AC power sources to the plurality of loads based on the input parameter.

17. The method of claim 16, further comprising:
determining a current switching count and a current balancing ratio associated with the load balancing unit, wherein the current switching count is indicative of a number of switches between the plurality of AC power sources in a given time period, and wherein the current balancing ratio is indicative of a difference in energy consumption from the AC power sources;
modifying the balancing ratio of the load balancing unit if the current switching count is lesser than the minimum switching count or the current switching count is greater than the maximum switching count; and
displaying the current switching count and the current balancing ratio to the user.

18. The method of claim 13, wherein the historical data corresponding to each of the plurality of AC power sources comprises a power fluctuation data and an Availability of Service (AoS) data.

19. A system for use with a plurality of Alternating Current (AC) power sources and a plurality of loads, the system comprising:
a load balancing unit configured to distribute power from the plurality of AC power sources to the plurality of loads;
a monitoring unit configured to monitor an energy consumption from each of the plurality of AC power sources and a power consumption of each of the plurality of loads;
a communication unit including a Radio-Frequency Identification (RFID) reader configured to receive a load identifier from a RFID tag associated with a corresponding load of the plurality of loads, wherein the load identifier is at least indicative of a power rating of the corresponding load;
a memory unit configured to store historical data corresponding to each of the plurality of AC power sources and a tariff rate of each of the plurality of AC power sources, wherein the historical data corresponding to each of the plurality of AC power sources includes a power fluctuation data and an Availability of Service (AoS) data;
a user interface configured to receive a user preference indicative of at least one of a Quality of Service (QoS) from the plurality of AC power sources, a cost associated with the energy consumption from the plurality of AC power sources and a maximum power limit for at least one of the plurality of loads; and
a controller communicably coupled to the load balancing unit, the monitoring unit, the communication unit, the memory unit and the user interface, the controller configured to:
determine a QoS parameter for each of the plurality of AC power sources based on the historical data corresponding to each of the plurality of AC power sources;
regulate, by the load balancing unit, the distribution of power from the plurality of AC power sources to the plurality of loads based on at least the energy consumption from each of the plurality of AC power sources, the power rating of each of the plurality of loads, the QoS parameter of each of the plurality of AC power sources, the tariff rate of each of the plurality of AC power sources and the user preference; and
display, through the user interface, the energy consumption from each of the plurality of AC power sources, the power consumption of each of the plurality of loads and the distribution of power from the plurality of AC power sources to the plurality of loads.

20. The system of claim 19, wherein the controller is further configured to:
determine a current switching count and a current balancing ratio associated with the load balancing unit, wherein the current switching count is indicative of a number of switches between the plurality of AC power sources in a given time period, and wherein the current balancing ratio is indicative of a difference in energy consumption from the AC power sources;
modify the balancing ratio of the load balancing unit if the current switching count falls outside a predetermined switching count range; and
display, through the user interface, the current switching count and the current balancing ratio to the user.
